(19) United States
(12) Patent Application Publication
(10) Pub. No.: US 2013/0250879 A1
(43) Pub. Date: Sep. 26, 2013

(54) METHOD AND APPARATUS FOR TRANSMISSION MODE DESIGN FOR EXTENSION CARRIER OF LTE ADVANCED

(71) Applicant: SAMSUNG ELECTRONICS CO., LTD, Suwon-si (KR)

(72) Inventors: Boon Loong Ng, Dallas, TX (US); Young-Han Nam, Richardson, TX (US); Jianzhong Zhang, Plano, TX (US)

(73) Assignee: SAMSUNG ELECTRONICS CO., LTD, Suwon-si (KR)

(21) Appl. No.: 13/841,538

(22) Filed: Mar. 15, 2013

Related U.S. Application Data
(60) Provisional application No. 61/614,322, filed on Mar. 22, 2012.

(51) Int. Cl. H04W 72/04

(52) U.S. Cl. CPC H04W 72/042
USPC 370/329

(57) ABSTRACT

A system and method includes transmission mode design for Extension Carrier of LTE-Advanced. The system includes a base station capable of communicating with subscriber stations using an extension carrier. The extension carrier is not backwards compatible and does not transmit any LTE Release 8-10 cell-specific reference signals (CRS) or Physical Downlink Control Channel. The system including transmission mode design for Extension Carrier of LTE-Advanced uses a basic demodulation reference signal transmission scheme (Basic DM-RS TS) when the PDSCH transmission uses DCI format 1A. Basic DM-RS TS uses DM-RS ports and does not uses CRS ports.

### CROSS-REFERENCE TO RELATED APPLICATION(S) AND CLAIM OF PRIORITY

The present application claims priority to U.S. Provisional Patent Application Ser. No. 61/614,322, filed Mar. 22, 2012, entitled “METHODS AND APPARATUS FOR TRANSMISSION MODE DESIGN FOR EXTENSION CARRIER OF LTE-ADVANCED.” The content of the above-identified patent document is incorporated herein by reference.

### TECHNICAL FIELD

The present application relates generally to wireless communication systems and, more specifically, to a transmission mode design for extension carrier of Long Term Evolution-Advanced (LTE-Advanced).

### BACKGROUND

LTE defines downlink physical channels to carry information blocks received from the Medium Access Control (MAC) layer and higher layers. These channels are categorized as transport channels or control channels.

In the 3GPP LTE systems, a physical resource block (PRE) pair is composed of two time slots. Rel-12 will introduce a new carrier type for improving spectral efficiency and energy efficiency by reducing or eliminating common control and reliance of legacy cell-specific reference signals by the user equipment for channel estimation for receiving the data channel. The user equipment (UE) may rely purely on the UE-specific reference signal (UE-RS) (or demodulation reference signal (DM-RS)) for channel estimation for receiving the data channel on the new carrier. LTE Release 8-10 uses cell-specific reference signals (CRS) for channel estimation.

### SUMMARY

A base station configured to communicate with a plurality of subscriber stations is provided. The base station includes a transmit path configured to transmit data and control information on a non-backwards compatible extension carrier. The base station includes processing circuitry coupled to the transmit path and configured to select a Basic Demodulation Reference Signal Transmission Scheme (Basic DM-RS TS) of Physical Downlink Shared Channel (PDSCH) corresponding to Physical Downlink Control Channel (PDCCH). The Basic DM-RS TS uses DM-RS ports for PDSCH transmission using DCI format 1A.

A method for communicating with a plurality of subscriber stations is provided. The method includes transmitting data and control information on a non-backwards compatible extension carrier. The method includes selecting a Basic Demodulation Reference Signal Transmission Scheme (Basic DM-RS TS) of Physical Downlink Shared Channel (PDSCH) corresponding to Physical Downlink Control Channel (PDCCH). The Basic DM-RS TS uses DM RS ports for PDSCH transmission using DCI format 1A.

A subscriber station configured to communicate with at least one base station is provided. The subscriber station includes a receive path configured to receive data and control information from a carrier of a first type and a carrier of a second type of the at least one base station. The second type carrier is a non-backwards compatible extension carrier. The first type carrier is a LTE Release 8 carrier or a LTE Release 10 carrier. The processing circuitry is coupled to the receive path and configured to make a selection, based on the carrier type. In making the selection, the subscriber station selects at least one of: a Basic DM-RS TS for PDSCH demodulation for a transmission mode; a downlink power allocation assumption; a basic DM-RS TS for CSI feedback; and a default transmission mode to use for a carrier. The subscriber station is configured to receive, from the at least one base station, UE-specific signaling indicating the carrier type.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to an embodiment of the present disclosure;

FIG. 2A illustrates a high-level diagram of a wireless transmit path according to an embodiment of this disclosure;

FIG. 2B illustrates a high-level diagram of a wireless receive path according to an embodiment of this disclosure;

FIG. 3 illustrates a subscriber station according to an exemplary embodiment of the disclosure;

FIG. 4 illustrates PDCCH and PDSCH configured by C-RNTI according to embodiments of the present disclosure;

FIG. 5 illustrates Basic DM-RS TS configurable by higher layer signaling according to embodiments of the present disclosure;

FIG. 6 illustrates PDCCH and PDSCH configured by SI-RNTI according to embodiments of the present disclosure;

FIG. 7 illustrates PDCCH and PDSCH configured by P-RNTI according to embodiments of the present disclosure;

FIG. 8 illustrates PDCCH and PDSCH configured by RA-RNTI according to embodiments of the present disclosure;

FIG. 9 illustrates the default transmission mode configurable to be dependent upon higher layer signaling according to embodiments of the present disclosure;

FIG. 10 illustrates the assumptions of a Rel-11 UE regarding the PDSCH transmission scheme assumed for CSI reference resource for TM8 or TM9 according to embodiments of the present disclosure;

FIG. 11 illustrates the Basic DM-RS TS for CSI feedback configurable by higher layer signaling according to embodiments of the present disclosure;

FIG. 12 illustrates the Basic DM-RS TS for CSI feedback configured the same as that used for PDSCH demodulation according to embodiments of the present disclosure; and

FIG. 13 illustrates a mapping of UE-specific reference signals, antenna ports 7 and 8 for an extended cyclic prefix according to embodiments of the present disclosure.

### DETAILED DESCRIPTION

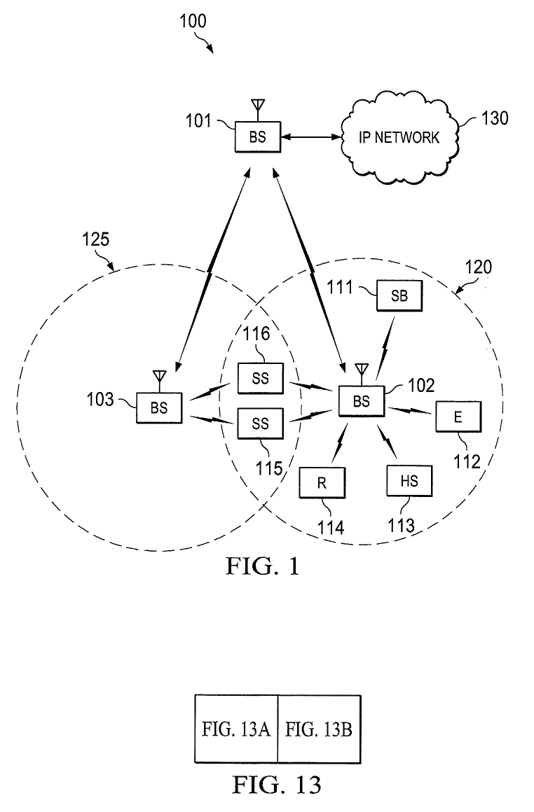

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein: (i) 3GPP Technical Specification No. 36.211, version 11.2.0, “E-UTRA, Physical Channels and Modulation” (hereinafter “REF1”); (ii) 3GPP Technical Specification No. 36.212, version 11.2.0, “E-UTRA, Multiplexing and Channel Coding” (hereinafter “REF2”); (iii) 3GPP Technical Specification No. 36.213, version 11.2.0, “E-UTRA, Physical Layer Procedures” (hereinafter “REF3”); and (iv) 3GPP Technical Specification No. 36.214, version 11.1.0, “E-UTRA, Physical Layer Measurement” (hereinafter “REF4”).

In wireless communications systems, such as LTE, transport channels include the Physical Broadcast Channel (PBCH) and the PDSCH. The PBCH broadcasts parameters for access, such as downlink system bandwidth. The PDSCH is a main channel for communicating data, and the channel is allocated to users on a dynamic and opportunistic basis. The PDSCH carries data in Transport Blocks (TB) that correspond to a MAC protocol data unit. The PDSCH also transmits broadcast information not transmitted on the PBCH, including System Information Blocks (SIB) and paging messages. The Physical Downlink Control Channel (PDCCH) is an example of a control channel. The PDCCH carries, in a Downlink Control Information (DCI) message, the resource assignment for UEs.

FIG. 1 illustrates a wireless network 100 according to one embodiment of the present disclosure. The embodiment of wireless network 100 illustrated in FIG. 1 is for illustration only. Other embodiments of wireless network 100 could be used without departing from the scope of this disclosure.

The wireless network 100 includes eNodeB (eNB) 101, eNB 102, and eNB 103. The eNB 101 communicates with eNB 102 and eNB 103. The eNB 101 also communicates with Internet protocol (IP) network 130, such as the Internet, a proprietary IP network, or other data network.

Depending on the network type, other well-known terms may be used instead of “eNodeB,” such as “base station” or “access point”. For the sake of convenience, the term “eNodeB” shall be used herein to refer to the network infrastructure components that provide wireless access to remote terminals. In addition, the term user equipment (UE) is used herein to refer to remote terminals or any remote wireless equipment that wirelessly accesses an eNB, whether the UE is a mobile device (e.g., cell phone) or is normally considered a stationary device (e.g., desktop personal computer, vending machine, etc.). In other systems, other well-known terms may be used instead of “user equipment”, such as “mobile station” (MS), “subscriber station” (SS), “remote terminal” (RT), “wireless terminal” (WT), and the like.

The eNB 102 provides wireless broadband access to network 130 to a first plurality of user equipments (UEs) within coverage area 120 of eNB 102. The first plurality of UEs includes UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device, such as a cell phone, a wireless laptop, a wireless PDA, or the like. UEs 111-116 may be any wireless communication device, such as, but not limited to, a mobile phone, mobile PDA and any mobile station (MS).

The eNB 103 provides wireless broadband access to a second plurality of UEs within coverage area 125 of eNB 103. The second plurality of UEs includes UE 115 and UE 116. In some embodiments, one or more of eNBs 101-103 may communicate with each other and with UEs 111-116 using Long Term Evolution (LTE) or LTE-Advanced (LTE-A) techniques including techniques for: transmitting signals on a non-backward compatible extension carrier and excluding transmitting LTE Release 8-10 Physical Downlink Control Channel (PDCCH) and cell-specific reference signals.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Although FIG. 1 depicts one example of a wireless network 100, various changes may be made to FIG. 1. For example, another type of data network, such as a wired network, may be substituted for wireless network 100. In a wired network, network terminals may replace eNBs 101-103 and UEs 111-116. Wired connections may replace the wireless connections depicted in FIG. 1.

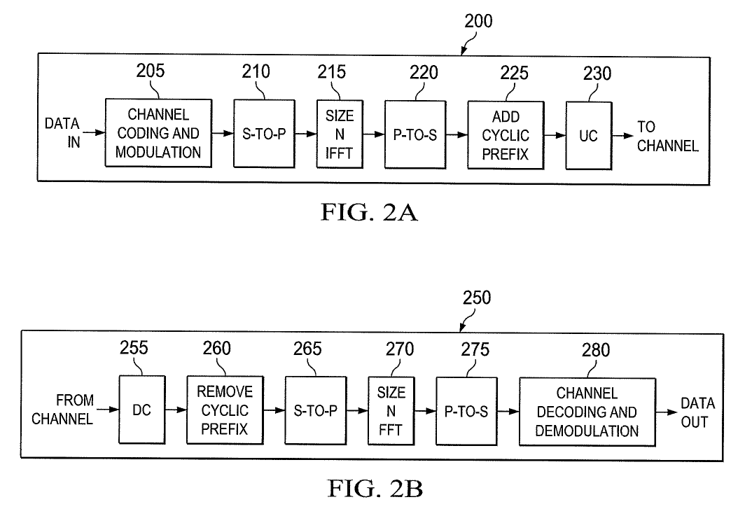

FIG. 2A is a high-level diagram of a wireless transmit path. FIG. 2B is a high-level diagram of a wireless receive path. In FIGS. 2A and 2B, the transmit path 200 may be implemented, e.g., in eNB 102 and the receive path 250 may be implemented, e.g., in a UE, such as UE 116 of FIG. 1. It will be understood, however, that the receive path 250 could be implemented in an eNB (e.g. eNB 102 of FIG. 1) and the transmit path 200 could be implemented in a UE. In certain embodiments, transmit path 200 and receive path 250 are configured to perform methods for transmitting signals on a non-backward compatible extension carrier and excluding transmitting LTE Release 8-10 Physical Downlink Control Channel (PDCCH) and cell-specific reference signals.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. Receive path 250 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware (e.g., a processor) or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of this disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., Turbo coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in eNB 102 and UE 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at UE 116 after passing through the wireless channel and reverse operations to those at eNB 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of eNBs 101-103 may implement a transmit path that is analogous to transmitting in the downlink to UEs 111-116 and may implement a receive path that is analogous to receiving in the uplink from UEs 111-116. Similarly, each one of UEs 111-116 may implement a transmit path corresponding to the architecture for transmitting in the uplink to eNBs 101-103 and may implement a receive path corresponding to the architecture for receiving in the downlink from eNBs 101-103.

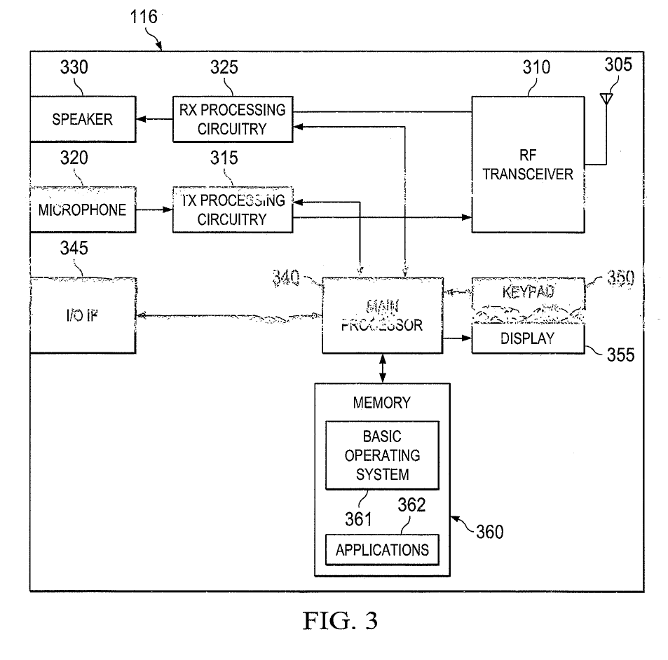

FIG. 3 illustrates a subscriber station according to embodiments of the present disclosure. The embodiment of subscribe station, such as UE 116, illustrated in FIG. 3 is for illustration only. Other embodiments of the wireless subscriber station could be used without departing from the scope of this disclosure.

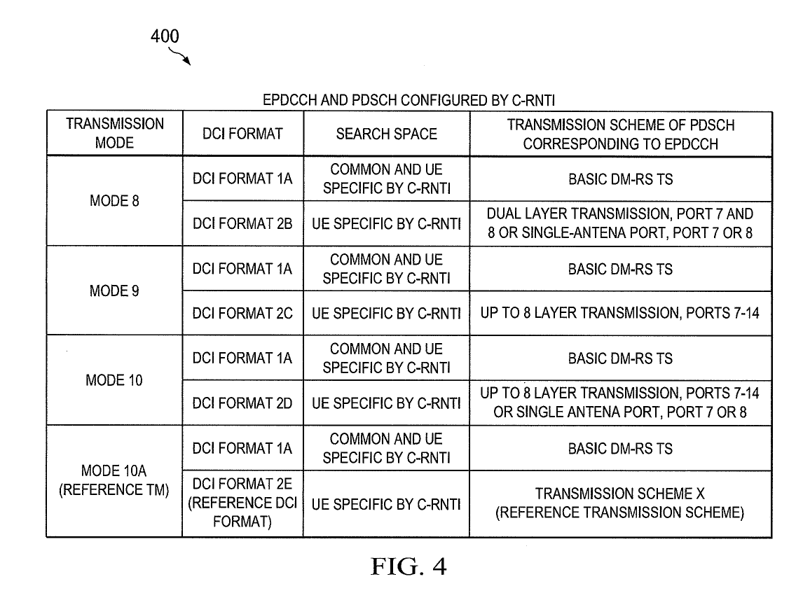

UE 116 comprises antenna 305, radio frequency (RF) transceiver 310, transmit (TX) processing circuitry 315, microphone 320, and receive (RX) processing circuitry 325. SS 116 also comprises speaker 330, main processor 340, input/output (I/O) interface (IF) 345, keypad 350, display 355, and memory 360. Memory 360 further comprises basic operating system (OS) program 361 and a plurality of applications 362. The plurality of applications can include one or more of resource mapping tables (FIGS. 4-12 described in further detail herein below).

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In certain embodiments, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless UE 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360, such as multi-stage time-division multiplexed LDPC decoding processes described in embodiments of the present disclosure. Main processor 340 can move data into or out of memory 360, as required by an executing process. In some embodiments, the main processor 340 is configured to execute a plurality of applications 362, such as applications for coordinated multi-point (CoMP) communications and multi-user multiple-input and multiple-output (MU-MIMO) communications. The main processor 340 can operate the plurality of applications 362 based on OS program 361 or in response to a signal received from BS 102. Main processor 340 is also coupled to I/O interface 345. I/O interface 345 provides UE 116 with the ability to connect to other devices such as laptop computers and handheld computers. I/O interface 345 is the communication path between these accessories and main controller 340.

Main processor 340 is also coupled to keypad 350 and display unit 355. The operator of UE 116 uses keypad 350 to enter data into UE 116. Display 355 may be a liquid crystal display capable of rendering text and/or at least limited graphics from web sites. Alternate embodiments may use other types of displays.

LTE Release 12 (Rel-12) may include an extension carrier (also known as New Carrier Type), which is a non-backward compatible carrier. The extension carrier does not transmit any LTE Release 8 (Rel-8), LTE Release 9 (Rel-8), LTE Release 10, or LTE Release 11 cell-specific reference signals. The LTE Rel-11 carrier does not transmit any Rel-8, Rel-9, Rel-10, or Rel-11 Physical Downlink Control Channel (PDCCH).

The Physical Downlink Shared Channel (PDSCH) transmission schemes for Rel-8, Rel-9, Rel-10, Rel-11 LTE include the following schemes: Single-antenna Port scheme; Transmit Diversity scheme; Large Delay Cyclic Delay Diversity (CDD) scheme; Closed-loop Spatial Multiplexing scheme; Multi-user (MU) Multiple Input Multiple Output (MIMO) scheme; Dual Layer scheme; and Up to 8 Later Transmission scheme. According to the Single-antenna Port schemes of the PDSCH for port numbers 0, 5, 7, or 8, UE 116 is configured to expect that an eNB transmission, such as from eNB 102, on the PDSCH would be performed according to Section 6.3.4.1 of 3GPP Technical Specification 36.211 version 11.2.0, “Evolved Universal Terrestrial Radio Access (E-UTRA); Physical channels and modulation” (also referred to as TS36.211), the contents of which are hereby incorporated by reference in their entirety. When UE 116 uses one of the antenna ports within the set pε{7,8}, UE 116 does not assume that the other antenna port in the set {7,8} is not associated with transmission of PDSCH to a second UE, such as UE 115.

According to Transmit Diversity Scheme of the PDSCH, UE 116 assumes that an eNB transmission, such as from eNB 102, on the PDSCH is performed according to Section 6.3.4.3 of TS36.211.

According to a large delay cyclic delay diversity (CDD) scheme of the PDSCH, UE 116 assumes that an eNB transmission, such as from eNB 102, on the PDSCH is performed according to large delay CDD as defined in Section 6.3.4.2.2 of TS36.211.

According to a Closed-loop Spatial Multiplexing scheme of the PDSCH, UE 116 assumes that an eNB transmission, such as from eNB 102, on the PDSCH is performed according to the applicable number of transmission layers as defined in Section 6.3.4.2.1 of TS36.211.

According to a MU-MIMO transmission scheme of the PDSCH, UE 116 assumes that an eNB transmission, such as from eNB 102, on the PDSCH would be performed on one layer and according to Section 6.3.4.2.1 of TS36.211. The δ_{power-offset} dB value of a signal on the PDCCH with Downlink Control Information (DCI) format 1D using the downlink power offset field is given in Table 1.

TABLE 1
Mapping of downlink power offset filed in DCI
format 1D to the δ_{power-offset} dB value.

| Downlink power offset field | δ_{power-offset} [dB] |
|---|---|
| 0 | −10 log₁₀(2) |
| 1 | 0 |

According to a Dual Layer scheme of the PDSCH, UE 116 assumes that an eNB transmission, such as from eNB 102, on the PDSCH would be performed with two transmission layers on antenna ports 7 and 8 as defined in Section 6.3.4.4 of TS36.211.

According to an ‘Up to 8’ Later Transmission scheme of the PDSCH, UE 116 assumes that an eNB transmission on the PDSCH would be performed with up to 8 transmission layers on antenna ports 7 through 14 as defined in Section 6.3.4.4 of TS36.211.

In Rel-11, the transmission scheme used by UE 116 to receive PDSCH depends on the radio network temporary identifier (RNTI), the transmission mode and the number of physical broadcast channel (PBCH) antenna ports, as illustrated in Tables 2-7. Transmission schemes that rely on demodulation reference signals (DM-RS) need to be defined because the extension carrier does not transmit cell-specific reference signals (CRS) for PDSCH demodulation purposes.

TABLE 2
PDCCH and PDSCH configured by System
Information RNTI (SI-RNTI)

| | Search | Transmission scheme of PDSCH |
|---|---|---|
| DCI format | Space | corresponding to PDCCH |
| DCI format 1C | Common | If the number of PBCH antenna ports is |
| | | one, Single-antenna port, port 0 is used, |
| | | otherwise Transmit diversity. |
| DCI format 1A | Common | If the number of PBCH antenna ports is |
| | | one, Single-antenna port, port 0 is used, |
| | | otherwise Transmit diversity |

TABLE 3
PDCCH and PDSCH configured by Paging-RNTI (P-RNTI)

| | Search | Transmission scheme of PDSCH |
|---|---|---|
| DCI format | Space | corresponding to PDCCH |
| DCI format 1C | Common | If the number of PBCH antenna ports is |
| | | one, Single-antenna port, port 0 is used, |
| | | otherwise Transmit diversity |
| DCI format 1A | Common | If the number of PBCH antenna ports is |
| | | one, Single-antenna port, port 0 is used, |
| | | otherwise Transmit diversity |

TABLE 4
PDCCH and PDSCH configured by
Random Access RNTI (RA-RNTI)

| | Search | Transmission scheme of PDSCH |
|---|---|---|
| DCI format | Space | corresponding to PDCCH |
| DCI format 1C | Common | If the number of PBCH antenna ports is |
| | | one, Single-antenna port, port 0 is used, |
| | | otherwise Transmit diversity |
| DCI format 1A | Common | If the number of PBCH antenna ports is |
| | | one, Single-antenna port, port 0 is used, |
| | | otherwise Transmit diversity |

TABLE 5
PDCCH and PDSCH configured by Cell Radio Network Temporary Identifier (C-RNTI)

| Transmission | | | Transmission scheme of PDSCH |
|---|---|---|---|
| mode | DCI format | Search Space | corresponding to PDCCH |
| Mode 1 | DCI format 1A | Common and | Single-antenna port, port 0 |
| | | UE specific by C-RNTI | |
| | DCI format 1 | UE specific by C-RNTI | Single-antenna port, port 0 |
| Mode 2 | DCI format 1A | Common and | Transmit diversity |
| | | UE specific by C-RNTI | |
| | DCI format 1 | UE specific by C-RNTI | Transmit diversity |
| Mode 3 | DCI format 1A | Common and | Transmit diversity |
| | | UE specific by C-RNTI | |
| | DCI format 2A | UE specific by C-RNTI | Large delay CDD or Transmit |
| | | | diversity |
| Mode 4 | DCI format 1A | Common and | Transmit diversity |
| | | UE specific by C-RNTI | |
| | DCI format 2 | UE specific by C-RNTI | Closed-loop spatial multiplexing |
| | | | or Transmit diversity |
| Mode 5 | DCI format 1A | Common and | Transmit diversity |
| | | UE specific by C-RNTI | |
| | DCI format 1D | UE specific by C-RNTI | Multi-user MIMO |
| Mode 6 | DCI format 1A | Common and | Transmit diversity |
| | | UE specific by C-RNTI | |
| | DCI format 1B | UE specific by C-RNTI | Closed-loop spatial multiplexing |
| | | | using a single transmission layer |
| Mode 7 | DCI format 1A | Common and | If the number of PBCH antenna ports |
| | | UE specific by C-RNTI | is one, Single-antenna port, port 0 |
| | | | is used, otherwise Transmit |
| | DCI format 1 | UE specific by C-RNTI | Single-antenna port, port 5 |
| Mode 8 | DCI format 1A | Common and | If the number of PBCH antenna ports |
| | | UE specific by C-RNTI | is one, Single-antenna port, port 0 |
| | | | is used, otherwise Transmit |
| | | | diversity |
| | DCI format 2B | UE specific by C-RNTI | Dual layer transmission, port 7 and |
| | | | 8 or single-antenna port, port 7 or 8 |
| Mode 9 | DCI format 1A | Common and | Non- Multicast-Broadcast Single |
| | | UE specific by C-RNTI | Frequency Network (Non-MBSFN) |
| | | | subframe: If the number of PBCH |
| | | | antenna ports is one, Single- |
| | | | antenna port, port 0 is used, |
| | | | otherwise Transmit diversity |
| | | | MBSFN subframe: Single-antenna |
| | | | port, port 7 |
| | DCI format 2C | UE specific by C-RNTI | Up to 8 layer transmission, ports 7-14 |
| Mode 10 | DCI format 1A | Common and | Non-MBSFN subframe: If the number |
| | | UE specific by C-RNTI | of PBCH antenna ports is one, |
| | | | Single-antenna port, port 0 is used, |
| | | | otherwise Transmit diversity |
| | | | MBSFN subframe: Single-antenna |
| | | | port, port 7 |
| | DCI format 2D | UE specific by C-RNTI | Up to 8 layer transmission, ports 7-14 |
| | | | or single-antenna port, port 7 or 8 |

TABLE 5A
EPDCCH and PDSCH configured by Cell Radio
Network Temporary Identifier (C-RNTI)

| Transmission | | | Transmission scheme of PDSCH |
|---|---|---|---|
| mode | DCI format | Search Space | corresponding to EPDCCH |
| Mode 1 | DCI format 1A | UE specific | Single-antenna port, port 0 |
| | DCI format 1 | UE specific | Single-antenna port, port 0 |
| Mode 2 | DCI format 1A | UE specific | Transmit diversity |
| | DCI format 1 | UE specific | Transmit diversity |
| Mode 3 | DCI format 1A | UE specific | Transmit diversity |
| | DCI format 2A | UE specific | Large delay CDD or Transmit |
| | | | diversity |
| Mode 4 | DCI format 1A | UE specific | Transmit diversity |
| | DCI format 2 | UE specific | Closed-loop spatial multiplexing |
| | | | or Transmit diversity |
| Mode 5 | DCI format 1A | UE specific | Transmit diversity |
| | DCI format 1D | UE specific | Multi-user MIMO |
| Mode 6 | DCI format 1A | UE specific | Transmit diversity |
| | DCI format 1B | UE specific | Closed-loop spatial multiplexing |
| | | | using a single transmission layer |
| Mode 7 | DCI format 1A | UE specific | If the number of PBCH antenna ports |
| | | | is one, Single-antenna port, port 0 |
| | | | is used, otherwise Transmit diversity |
| | DCI format 1 | UE specific | Single-antenna port, port 5 |
| Mode 8 | DCI format 1A | UE specific | If the number of PBCH antenna ports |
| | | | is one, Single-antenna port, port 0 |
| | | | is used, otherwise Transmit diversity |
| | DCI format 2B | UE specific | Dual layer transmission, port 7 and |
| | | | 8 or single-antenna port, port 7 or 8 |
| Mode 9 | DCI format 1A | UE specific | Non-MBSFN subframe: If the number |
| | | | of PBCH antenna ports is one, |
| | | | Single-antenna port, port 0 is used |
| | | | (see subclause 7.1.1), otherwise |
| | | | Transmit diversity |
| | | | MBSFN subframe: Single-antenna |
| | | | port, port 7 |
| | DCI format 2C | UE specific | Up to 8 layer transmission, ports 7-14 |
| | | | or single-antenna port, port 7 or 8 |
| Mode 10 | DCI format 1A | UE specific | Non-MBSFN subframe: If the number |
| | | | of PBCH antenna ports is one, |
| | | | Single-antenna port, port 0 is used, |
| | | | otherwise Transmit diversity |
| | | | MBSFN subframe: Single-antenna |
| | | | port, port 7 |
| | DCI format 2D | UE specific | Up to 8 layer transmission, ports 7-14 |
| | | | or single-antenna port, port 7 or 8 |

TABLE 6
PDCCH and PDSCH configured by Semi-Persistent
Scheduling Cell RNTI (SPS-C-RNTI)

| Transmission | | | Transmission scheme of PDSCH |
|---|---|---|---|
| mode | DCI format | Search Space | corresponding to PDCCH |
| Mode 1 | DCI format 1A | Common and | Single-antenna port, port 0 |
| | | UE specific by C-RNTI | |
| | DCI format 1 | UE specific by C-RNTI | Single-antenna port, port 0 |
| Mode 2 | DCI format 1A | Common and | Transmit diversity |
| | | UE specific by C-RNTI | |
| | DCI format 1 | UE specific by C-RNTI | Transmit diversity |
| Mode 3 | DCI format 1A | Common and | Transmit diversity |
| | | UE specific by C-RNTI | |
| | DCI format 2A | UE specific by C-RNTI | Transmit diversity |
| Mode 4 | DCI format 1A | Common and | Transmit diversity |
| | | UE specific by C-RNTI | |
| | DCI format 2 | UE specific by C-RNTI | Transmit diversity |
| Mode 5 | DCI format 1A | Common and | Transmit diversity |
| | | UE specific by C-RNTI | |
| Mode 6 | DCI format 1A | Common and | Transmit diversity |
| | | UE specific by C-RNTI | |
| Mode 7 | DCI format 1A | Common and | Single-antenna port, port 5 |
| | | UE specific by C-RNTI | |
| | DCI format 1 | UE specific by C-RNTI | Single-antenna port, port 5 |
| Mode 8 | DCI format 1A | Common and | Single-antenna port, port 7 |
| | | UE specific by C-RNTI | |
| | DCI format 2B | UE specific by C-RNTI | Single-antenna port, port 7 or 8 |
| Mode 9 | DCI format 1A | Common and | Single-antenna port, port 7 |
| | | UE specific by C-RNTI | |
| | DCI format 2C | UE specific by C-RNTI | Single-antenna port, port 7 or 8 |
| Mode 10 | DCI format 1A | Common and | Single-antenna port, port 7 |
| | | UE specific by C-RNTI | |
| | DCI format 2D | UE specific by C-RNTI | Single-antenna port, port 7 or 8 |

TABLE 6A
PDCCH and PDSCH configured by Semi-Persistent
Scheduling Cell RNTI (SPS-C-RNTI)

| Transmission | | | Transmission scheme of PDSCH |
|---|---|---|---|
| mode | DCI format | Search Space | corresponding to EPDCCH |
| Mode 1 | DCI format 1A | UE specific | Single-antenna port, port 0 |
| | DCI format 1 | UE specific | Single-antenna port, port 0 |
| Mode 2 | DCI format 1A | UE specific | Transmit diversity |
| | DCI format 1 | UE specific | Transmit diversity |
| Mode 3 | DCI format 1A | UE specific | Transmit diversity |
| | DCI format 2A | UE specific | Transmit diversity |
| Mode 4 | DCI format 1A | UE specific | Transmit diversity |
| | DCI format 2 | UE specific | Transmit diversity |
| Mode 5 | DCI format 1A | UE specific | Transmit diversity |
| Mode 6 | DCI format 1A | UE specific | Transmit diversity |
| Mode 7 | DCI format 1A | UE specific | Single-antenna port, port 5 |
| | DCI format 1 | UE specific | Single-antenna port, port 5 |
| Mode 8 | DCI format 1A | UE specific | Single-antenna port, port 7 |
| | DCI format 2B | UE specific | Single-antenna port, port 7 or 8 |
| Mode 9 | DCI format 1A | UE specific | Single-antenna port, port 7 |
| | DCI format 2C | UE specific | Single-antenna port, port 7 or 8 |
| Mode 10 | DCI format 1A | UE specific | Single-antenna port, port 7 |
| | DCI format 2D | UE specific | Single-antenna port, port 7 or 8 |

TABLE 7
PDCCH and PDSCH configured by Temporary C-RNTI

| | Search | Transmission scheme of PDSCH |
|---|---|---|
| DCI format | Space | corresponding to PDCCH |
| DCI format 1A | Common and | If the number of PBCH antenna port is |
| | UE specific | one, Single-antenna port, port 0 is used, |
| | by Temporary | otherwise Transmit diversity |
| | C-RNTI | |
| DCI format 1 | UE specific | If the number of PBCH antenna port is |
| | by Temporary | one, Single-antenna port, port 0 is used, |
| | C-RNTI | otherwise Transmit diversity |

For LTE Rel-10, in the channel state information (CSI) reference resource, UE 116 derives one or more of: the channel quality indicator (CQI) index, precoding matrix indicator (PMI), and rank indicator (RI) based on the following:

1) The first three Orthogonal Frequency Division Multiplexing (OFDM) symbols are occupied by control signaling;

2) No resource elements used by primary or secondary synchronization signals or PBCH;

3) Cyclic Prefix (CP) length of the non-MBSFN subframes.

4) Redundancy Version 0;

5) If CSI-RS is used for channel measurements (which may be always the case), the ratio of PDSCH Energy per Resource Element (EPRE) to CSI-RS EPRE is as given in Section 7.2.5; and

6) For transmission mode 9 CSI reporting: CRS REs are as in non-MBSFN subframes; if the UE is configured for PMI/RI reporting, the UE-specific reference signal overhead is consistent with the most recent reported rank; and PDSCH signals on antenna ports {7 . . . 6+υ} υ for layers would result in signals equivalent to corresponding symbols transmitted on antenna ports {15 . . . 14+P}, as provided by Equation 1:

$$[ \begin{matrix}{y}^{( 15 )} ( i ) \\ ⋮ \\ {y}^{( 14 + P )} ( i )\end{matrix} ] = W ( i ) [ \begin{matrix}{x}^{( 0 )} ( i ) \\ ⋮ \\ {x}^{( υ - 1 )} ( i )\end{matrix} ] , \qquad ( 1 )$$

where x(i)=[x⁽⁰⁾(i . . . x^{(υ-1)}(i)]^{T} is a vector of symbols from the layer mapping in section 6.3.3.2 of REF3, Pε{1,2,4,8} is the number of CSI-RS ports configured, and if only one CSI-RS port is configured, W(i) is 1, otherwise W(i) is the precoding matrix corresponding to the reported PMI applicable to 0); the corresponding PDSCH signals transmitted on antenna ports {15 . . . 14+P} would have a ratio of EPRE to CSI-RS EPRE equal to the ratio given in section 7.2.5. In certain embodiments, no REs allocated for CSI-RS and zero-power CSI-RS. In certain embodiments, no REs allocated for PRS. The PDSCH transmission scheme given by Table 8 depending on the transmission mode currently configured for the UE (which may be the default mode). If CRS is used for channel measurements, the ratio of PDSCH EPRE to cell-specific RS EPRE is as given in Section 5.2 with the exception of ρ_{A}, which is assumed to be ρ_{A}=P_{A}+Δ_{offset}+10 log₁₀ (2) [dB] for any modulation scheme. If UE 116 is configured with transmission mode-2 with four cell-specific antenna ports, or transmission mode-3 with four cell-specific antenna ports and the associated RI is equal to one. If CRS is used for channel measurements, the ratio of PDSCH EPRE to cell-specific RS EPRE is as given in Section 5.2, with the exception of ρ_{A}, which is assumed to ρ_{A}=P_{A}+Δ_{offset} [dB] for any modulation scheme and any number of layers, otherwise. The shift Δ_{offset} is given by the parameter nomPDSCH-RS-EPRE-Offset, which is configured by higher-layer signaling.

TABLE 8
PDSCH transmission scheme assumed for CSI reference resource

| Transmis- | |
|---|---|
| sion mode | Transmission scheme of PDSCH |
| 1 | Single-antenna port, port 0 |
| 2 | Transmit diversity |
| 3 | Transmit diversity if the associated rank |
| | indicator is 1, otherwise large delay CDD |
| 4 | Closed-loop spatial multiplexing |
| 5 | Multi-user MIMO |
| 6 | Closed-loop spatial multiplexing with a single |
| | transmission layer |
| 7 | If the number of PBCH antenna ports is one, |
| | Single-antenna port, port 0; otherwise Transmit |
| | diversity |
| 8 | If the UE is configured without PMI/RI reporting: |
| | if the number of PBCH antenna ports is one, |
| | single-antenna port, port 0; otherwise transmit |
| | diversity |
| | If the UE is configured with PMI/RI reporting: |
| | closed-loop spatial multiplexing |
| 9 | If the UE is configured without PMI/RI reporting: |
| | if the number of PBCH antenna ports is one, |
| | single-antenna port, port 0; otherwise transmit |
| | diversity |
| | If the UE is configured with PMI/RI reporting: if |
| | the number of CSI-RS ports is one, single-antenna |
| | port, port 7; otherwise up to 8 layer |
| | transmission, ports 7-14 (see subclause 7.1.5B) |

For more accurate CSI derivation by UE 116, the physical signal structure of the extension carrier may need to be taken into account when considering the appropriate UE assumptions about the CSI reference resource when deriving the CSI feedback.

Section 9.2.4 of TS36.331 defines that the default transmission mode is either transmission mode-1 (TM1) or transmission mode-2 (TM2) conditioned on the number of PBCH antenna ports: If the number of PBCH antenna ports is one, TM1 is used as default; otherwise TM2 is used as default. However, the default transmission mode for the extension carrier should not TM1 or TM2 as they rely on CRS for PDSCH demodulation.

Transmission Schemes

FIG. 4 illustrates EPDCCH and PDSCH configured by C-RNTI according to embodiments of the present disclosure. The embodiment of the EPDCCH and PDSCH 400 as configured by the C-RNTI shown in FIG. 4 is for illustration only. Other embodiments could be used without departing from the scope of this disclosure. A PDSCH transmission is scheduled by EPDCCH with cyclic redundancy check (CRC) scrambled by C-RNTI.

Transmission modes (TM) that rely on CRS (port 0, 1, 2, 3) for PDSCH transmission and CSI feedback (namely TM1, 2, 3, 4, 5, 6, and 7) cannot be used in the extension carrier because cell-specific reference signals (CRS) are not transmitted in the extension carrier. That is, the extension carrier is referred to as “non-backwards compatible” because the extension carrier is not capable of transmitting CRS, and as a result is also not capable of supporting transmission modes 1-7 of LTE Releases 8-10.

For transmission mode-8 (TM8), the transmission scheme of PDSCH uses DM-RS ports 7-8 when the PDCCH/EPDCCH uses DCI format 2B. For transmission mode-9 (TM9), the transmission scheme of PDSCH uses DM-RS ports 7-14 when the PDCCH/EPDCCH uses DCI format 2C. For transmission mode-10 (TM10), the transmission scheme of PDSCH uses DM-RS ports 7-14 when the PDCCH/EPDCCH uses DCI format 2D. For DCI format 1A, the transmission scheme in Rel-10/11 can use CRS ports (see Table 5). In certain embodiments, if TM8, TM9 or TM10 are supported in the extension carrier, in order to support PDSCH transmission using DCI format 1A in the extension carrier, then for TM8, TM9 and TM10, a transmission scheme that uses DM-RS ports (namely, ports 7-8 for TM8; ports 7-14 for TM9 and TM10) is always used for PDSCH transmission using DCI format 1A, hereafter referred to as the “Basic DM-RS Transmission Scheme (TS).” In certain embodiments, the EPDCCH and PDSCH configured by C-RNTI extends to any transmission modes that are supported in the extension carrier.

In certain embodiments using DM-RS port 7, for PDSCH transmission scheduled using DCI format 1A, the applicable transmission scheme can be a first alternative of the Basic DM-RS TS (hereinafter “Basic DM-RS TS 1”). According to the Basic DM-RS TS 1, since a single antenna port transmission scheme using DM-RS port 7 is already defined in Rel-10, the first alternative of the Basic DM-RS TS option has the advantage that of not introducing a new transmission scheme.

An example of the single antenna port transmission scheme is precoding cycling for each resource blocks where the precoder applied on DM-RS port and on the data can be different in frequency for different resource blocks. For TM9/10, UE 116 does not assume physical resource block (PRB) bundling when receiving the PDSCH using the Basic DM-RS TS, regardless of whether PMI/RI feedback is configured. There is no support for PRB bundling for TM8. That is, in this example, if UE 116 is configured with TM9, the condition for UE 116 for PRB bundling is modified as follows: UE 116 assumes that precoding granularity is multiple resource blocks in the frequency domain:

when PMI/RI feedback is configured; and

if the transmission scheme is not Basic DM-RS TS 1, which can be implied by the type of DCI format used for PDSCH scheduling (for example, DCI format 1A implies that the transmission scheme is Basic DM-RS TS 1).

As another example, the single antenna port transmission scheme is precoding cycling for each resource element (RE). In this case, precoding is not applied on the DM-RS and is applied only on the data. The precoding applied to the data for every RE can be predefined and known at both eNB 102 and UE 116.

In certain embodiments, a Transmit Diversity scheme uses multiple DM-RS ports, such as port 7 and port 8, as a second alternative of the Basic DM-RS TS (hereinafter “Basic DM-RS TS 2”). The Basic DM-RS TS 2 has the advantage that of providing better performance and transmission reliability than Basic DM-RS TS 1. Space Frequency Block Coding (SFBC) is an example of the DM-RS based transmit diversity scheme.

In certain embodiments, the Basic DM-RS TS is the transmission scheme used whenever “fallback transmission” is used in the extension carrier. “Fallback transmission” is generally needed to maintain connection between eNB 102 and UE 116 whenever there is a Radio Resource Control (RRC) reconfiguration of the TM where eNB 102 does not know the actual TM configured at UE 116. In certain embodiments, fallback transmission is scheduled using DCI format 1A. FIG. 4 shows that other DCI formats can be used in scheduling fallback transmission.

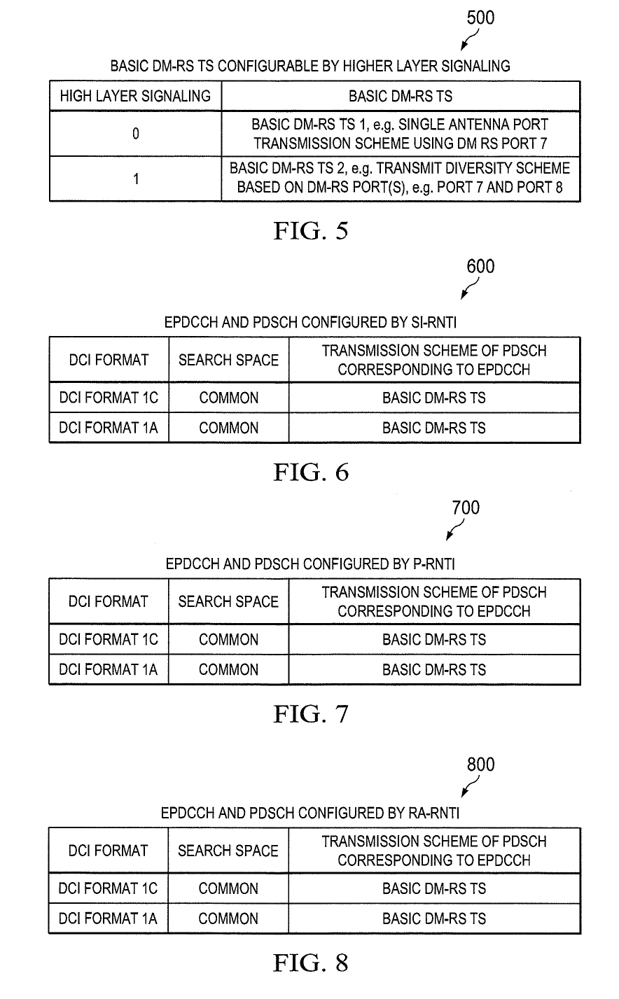

FIG. 5 illustrates Basic DM-RS TS configurable by higher layer signaling according to embodiments of the present disclosure. The embodiment of the Basic DM-RS TS 500 as configurable by the higher layer signaling shown in FIG. 5 is for illustration only. Other embodiments could be used without departing from the scope of this disclosure.

The Basic DM-RS transmission scheme (TS) is configurable to be a set value or as a value dependent upon higher layer signaling. Also, when a DM-RS based transmission scheme is used for Enhanced PDCCH (EPDCCH), the basic DM-RS TS used for the PDSCH is the same as that used for EPDCCH transmission. In certain embodiments, the Basic DM-RS TS is fixed or predefined as either Basic DM-RS TS 1 or as Basic DM-RS TS 2.

In certain embodiments, the Basic DM-RS TS is configured by higher layer signaling, such as by a Radio Resource Control (RRC). It is beneficial for the Basic DM-RS TS to be configured by higher layer signaling when the extension carrier is not a standalone carrier. That is, when the extension carrier is associated with another backward compatible carrier, the network configures UE 116 for the actual basic DM-RS TS to be used for the extension carrier. When higher layer signaling is set to a value of zero, the Basic DM-RS TS is the first alternative (Basic DM-RS TS 1), a single antenna port transmission scheme using DM-RS port 7. When higher layer signaling is set to a value of one, the Basic DM-RS TS is the second alternative (Basic DM-RS TS 2), a Transmit diversity scheme based on multiple DM-RS ports, such as port 7 and port 8.

FIG. 6 illustrates EPDCCH and PDSCH configured by SI-RNTI according to embodiments of the present disclosure. The embodiment of the table 600 for the EPDCCH and PDSCH configured by SI-RNTI shown in FIG. 6 is for illustration only. Other embodiments could be used without departing from the scope of this disclosure.

If EPDCCH with a CRC that is scrambled by the SI-RNTI (for scheduling System Information transmission) is used in the extension carrier, then a transmission scheme that does not require CRS ports is needed for the extension carrier. The table 600 for the basic DM-RS TS, shown in FIG. 6, is configured for the EPDCCH with a CRC scrambled by the SI-RNTI.

FIG. 7 illustrates EPDCCH and PDSCH configured by P-RNTI according to embodiments of the present disclosure. The embodiment of the EPDCCH and PDSCH configured by P-RNTI 700 shown in FIG. 7 is for illustration only. Other embodiments could be used without departing from the scope of this disclosure.

In certain embodiments, EPDCCH with CRC scrambled by the P-RNTI (for Paging) is used in the extension carrier, then a transmission scheme that does not require CRS ports are needed for the extension carrier. The basic DM-RS TS 705 is configured for the EPDCCH with a CRC scrambled by the P-RNTI.

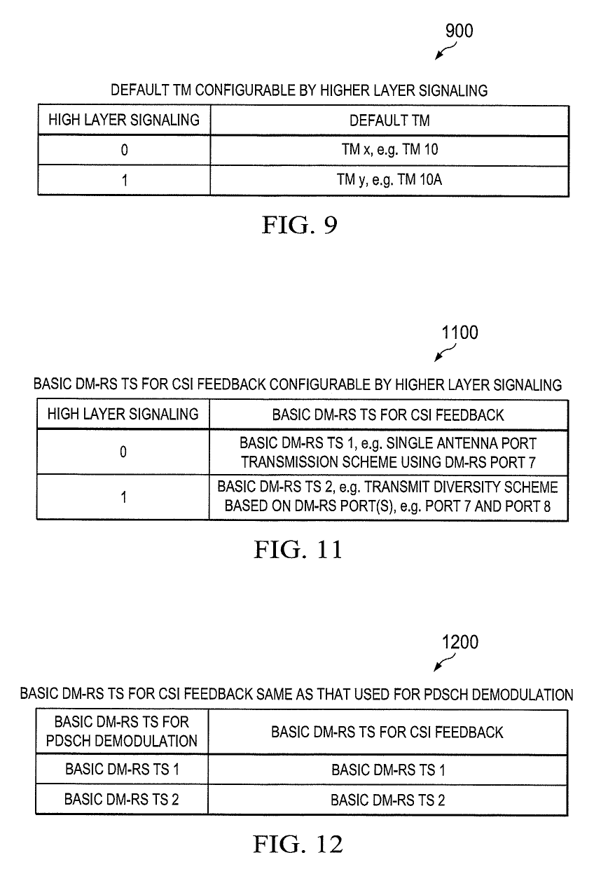

FIG. 8 illustrates EPDCCH and PDSCH configured by RA-RNTI according to embodiments of the present disclosure. The embodiment of the table 800 for the EPDCCH and PDSCH configured by RA-RNTI shown in FIG. 8 is for illustration only. Other embodiments could be used without departing from the scope of this disclosure.

In certain embodiments, an EPDCCH with CRC is scrambled by the RA-RNTI (for random access message 2) is used in the extension carrier. A transmission scheme that does not require CRS ports is needed for the extension carrier. The table 800 in FIG. 8 shows the basic DM-RS TS configured for the EPDCCH with CRC scrambled by the RA-RNTI.

In certain embodiments, EPDCCH with CRC is scrambled by the SPS-RNTI (for semi-persistent scheduling) is used in the extension carrier, then a transmission scheme that does not require CRS ports also is needed for the extension carrier.

Default Transmission Mode

In LTE Rel-10, TS36.331 specifies that if the number of PBCH antenna ports is one, then TM1 is used as default; otherwise TM2 is used as default. For the extension carrier, there are at least four alternatives for the default transmission mode: TM8 is the first alternative default TM; TM9 is the second alternative default TM; TM10 is the third alternative default TM; and new TM e.g. based on TM10 (denoted as TM10A) is the fourth alternative default TM.

FIG. 9 illustrates the default transmission mode configurable to be dependent upon higher layer signaling according to embodiments of the present disclosure. The embodiment of the default transmission mode 900 shown in FIG. 9 is for illustration only. Other embodiments could be used without departing from the scope of this disclosure.

In certain embodiments, the default transmission mode depends upon higher layer signaling such that a value of a higher layer signal determines the transmission mode (TM) to be used as the default. In certain embodiments, the network configures the default TM via higher layer signaling, such as a Radio Resource Control (RRC). As a benefit, if the extension carrier is not a standalone extension carrier (that is, a standalone extension carrier is associated with another backward compatible carrier), the network configures UE 116 with the default transmission mode to be used in the extension carrier.

In certain embodiments, the default transmission mode is configurable to be set to a fixed or predefined transmission mode. For example, the default transmission mode can be set to be TM9, wherein TM9 is a preferred default over TM10, which requires smaller DCI payload for the normal TS.

Downlink Power Allocation

For the extension carrier of TM8, UE 116 assumes that the ratio of PDSCH EPRE to UE-specific RS EPRE is zero (0) dB. For the extension carrier of TM9/10, UE 116 assumes that the ratio of PDSCH EPRE to UE-specific RS EPRE is 0 dB for a number N of transmission layers and −3 dB otherwise, wherein N is less than or equal to two.

For all transmission modes supported in the extension carrier, when the transmission mode supports only single layer and two layer transmissions, UE 116 assumes that the ratio of PDSCH EPRE to UE-specific RS EPRE is 0 dB. For all transmission modes supported in the extension carrier, when the transmission mode supports more than two layer transmission, UE 116 assumes that the ratio of PDSCH EPRE to UE-specific RS EPRE is 0 dB for N (i.e., N is less than or equal to two) transmission layers, and assumes that the ratio of PDSCH EPRE to UE-specific RS EPRE is −3 dB otherwise.

CSI Derivation Assumptions

In LTE Rel-8, Rel-9, Rel-10 and Rel-11, when deriving the channel quality indicator (CQI) index, UE 116 makes assumptions for the channel state indicator (CSI) resource. UE 116 assumes that the first three OFDM symbols are occupied by control signaling. UE 116 assumes that if CSI-RS is used for channel measurements, then the ratio of PDSCH EPRE to CSI-RS EPRE is as given in Section 7.2.5 of TS36.213. Additionally, UE 116 assumes that for TM9/10 CSI reporting, CRS Resource Elements (REs) are as in Non-Multicast-Broadcast Single Frequency Network (Non-MBSFN) subframes.

UE 116 performs a more accurate CQI derivation for the extension carrier than in LTE Rel-8, Rel-9, Rel-10, and Rel-11. In order to make the more accurate CQI derivation for the extension carrier, UE 116 makes the following assumptions for the CSI reference resource.

UE 116 assumes:

1) That zero OFDM symbols are occupied by control signaling because PDCCH is not transmitted in the extension carrier;

2) That no resource elements are used by primary or secondary synchronization signals or by PBCH;

3) A cyclic prefix (CP) length of the non-MBSFN subframes;

4) A Redundancy Version 0;

5) That if CSI-RS is used for channel measurements, the ratio of PDSCH EPRE to CSI-RS EPRE is given by P_{c}. P_{c} is the assumed ratio of PDSCH Energy per Resource Element (EPRE) to CSI-RS EPRE when the UE derives CSI feedback and takes values in the range of [−8, 15] dB with 1 dB step size, for all the OFDM symbols in the subframe;

6) For CSI reporting, if TM8 is supported, that no CRS REs are in the CSI reference resource because no CRS exists in the extension carrier;

7) Also for CSI reporting, if transmission mode 9/10 is supported, that no CRS REs is in the CSI reference resource because no CRS exist in the extension carrier.

In certain embodiments, when UE 116 is configured for PMI/RI reporting, UE 116 is configured to assume that the UE-specific reference signal overhead is consistent with the most recent reported rank. UE 116 assumes that PDSCH signals on antenna ports {7 . . . 6+v} for v layers would result in signals equivalent to corresponding symbols transmitted on antenna ports {15 . . . 14+P}, as given by the system of equations including Equation 2 and Equation 3:

$$\begin{matrix}[ \begin{matrix}{y}^{15} ( i ) \\ ⋮ \\ {y}^{( 14 + P )} ( i )\end{matrix} ] = W ( i ) = [ \begin{matrix}{x}^{0} ( i ) \\ ⋮ \\ {x}^{( v - 1 )} ( i )\end{matrix} ] & ( 2 ) \\ x ( i ) = {[ {x}^{( 0 )} ( i ) … {x}^{( v - 1 )} ( i ) ]}^{T} & ( 3 )\end{matrix}$$

In Equation 3, x(i) is a vector of symbols from the layer mapping in section 6.3.3.2 of TS 36.211, Pε{1,2,4,8} is the number of CSI-RS ports configured, and if only one CSI-RS port is configured, W(i) is 1, otherwise W(i) is the precoding matrix corresponding to the reported PMI applicable to x(i). The corresponding PDSCH signals transmitted on antenna ports{15 . . . 14+P} would have a ratio of EPRE to CSI-RS EPRE equal to the ratio given in section 7.2.5 of TS 36.211.

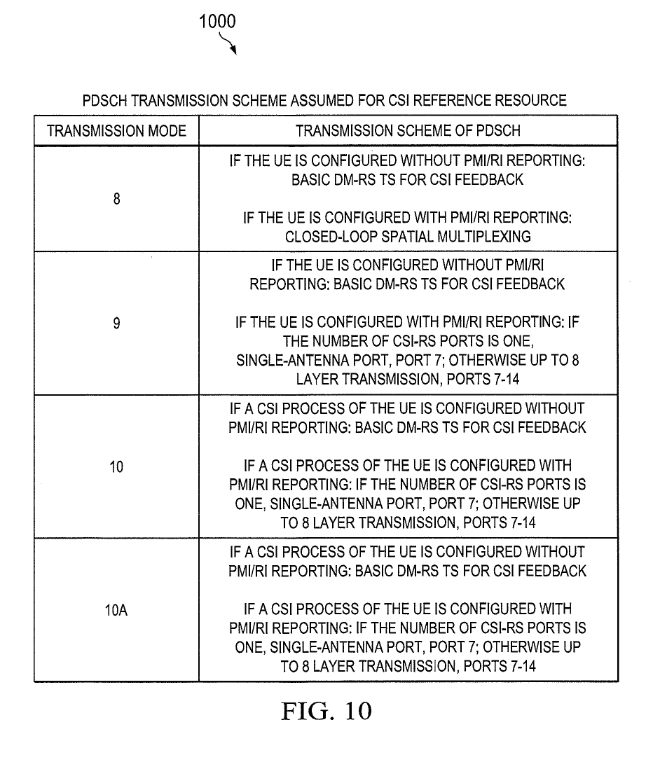

FIG. 10 illustrates the assumptions of a UE that supports extension carrier regarding the PDSCH transmission scheme assumed for CSI reference resource for TM8, TM9, TM10 or TM10A according to embodiments of the present disclosure. The embodiment of the PDSCH transmission scheme assumed for CSI reference resource 1000 shown in FIG. 10 is for illustration only. Other embodiments could be used without departing from the scope of this disclosure.

In certain embodiments, the basic DM-RS TS for CSI feedback is fixed and predefined, such as a single antenna port transmission scheme using DM RS port 7, or a Transmit diversity scheme based on multiple DM-RS ports (for example, port 7 and port 8).

FIG. 11 illustrates the Basic DM-RS TS for CSI feedback configurable by higher layer signaling according to embodiments of the present disclosure. The embodiment of the table 1100 for the Basic DM-RS TS for CSI feedback configurable by higher layer shown in FIG. 11 is for illustration only. Other embodiments could be used without departing from the scope of this disclosure. In certain embodiments, the basic DM-RS TS for CSI-feedback is configured to be determined based on a higher layer signaling. UE 116 can receive a dedicated message from eNB 102 configuring basic DM-RS TS for CSI-feedback. In certain embodiments, eNB 102 includes an indicator of the basic DM-RS TS for CSI-feedback configuration as part of another message.

FIG. 12 illustrates the Basic DM-RS TS for CSI feedback configured the same as that used for PDSCH demodulation according to embodiments of the present disclosure. The embodiment of the table 1200 for the Basic DM-RS TS for CSI feedback shown in FIG. 12 is for illustration only. Other embodiments could be used without departing from the scope of this disclosure. In certain embodiments, the basic DM-RS TS for CSI-feedback is the same as the basic DM-RS TS configured or defined for PDSCH demodulation as described in FIGS. 4-5. UE 116 is configured to determine the basic DM-RS TS for CSI-feedback configuration based on the PDSCH demodulation.

When the Basic DM-RS TS for CSI feedback is Basic DM-RS TS 1 (i.e., the single-antenna port transmission scheme using DM-RS port 7), the CSI is derived as if only one CSI-RS port is configured, relying only on antenna port 15. That is, PDSCH signals on antenna ports {7} for 1 layer would result in signals equivalent to corresponding symbols transmitted on antenna ports {15}, as given by y⁽¹⁵⁾(i)=x⁽⁰⁾(i), where x⁽⁰⁾(i) is a symbol from the layer mapping in section 6.3.3.2 of TS 36.211.

When the basic DM-RS TS for CSI feedback is Basic DM-RS TS 2 (i.e., the transmit diversity transmission scheme using DM-RS ports 7 and 8), the CSI is derived under the following two assumptions: channels estimated on CSI-RS port 15 are the same as channels estimated on DM-RS port 7; and channels estimated on CSI-RS port 16 are the same as channels estimated on DM-RS port 8. More particularly, PDSCH signals on antenna ports {7,8} for two layers would result in signals equivalent to corresponding symbols transmitted on antenna ports {15,16}, as given by the system of equations Equation 4 and 5:

$$\begin{matrix}[ \begin{matrix}{y}^{15} ( 2 i ) \\ {y}^{16} ( 2 i ) \\ {y}^{15} ( 2 i + 1 ) \\ {y}^{16} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] & ( 4 ) \\ x ( i ) = {[ \begin{matrix}{x}^{( 0 )} ( i ) & {x}^{( 1 )} ( i )\end{matrix} ]}^{T} & ( 5 )\end{matrix}$$

In Equation 5, x(i) is a vector of symbols from the layer mapping in section 6.3.3.3 of TS 36.211. Although illustrated as examples, embodiments according to FIGS. 10-12 are applicable to other TMs supported in the extension carrier.

Carrier Type Dependency

In certain embodiments, UE 116 implicitly configures, based on the carrier type, the default transmission mode that UE 116 should use for a carrier. In certain embodiments, UE 116 implicitly configures, based on the carrier type, one or more of: the basic DM-RS TS for PDSCH demodulation for a transmission mode; the downlink power allocation assumption; the basic DM-RS TS for CSI feedback (hereafter referred to as “the Basic PDSCH Demodulation method”).

Accordingly, UE 116 is configured to use the following basic DM-RS TS depending on the type of the component carrier. If the carrier type is a first carrier type, UE 115 uses a first basic PDSCH demodulation method (also referred to as a first default transmission mode). If the carrier type is a second carrier type, UE 116 uses a second basic PDSCH demodulation method (also referred to as a second default transmission mode). In certain embodiments, the first and the second carrier types are Rel-8 compatible carrier type and the new carrier type (e.g., of Rel-12). In certain embodiments, the first and the second PDSCH demodulation methods are the Rel-10/11 PDSCH demodulation method and a new PDSCH demodulation method. Examples of the new PDSCH demodulation method can be found in respective embodiments of TRANSMISSION SCHEMES, DOWNLINK POWER ALLOCATION, or CSI DERIVATION ASSUMPTIONS disclosed herein above with respect to FIGS. 4-12.

The carrier type of the component carrier can be communicated to UE 116 by UE-specific signaling in the RRC layer, or by a broadcast signaling. When UE 116 is configured as a secondary cell, an RRC configuration configuring the secondary cell can include an information field indicating the carrier type. For example, when the information field is 1, the secondary cell is the first carrier type; when the information field is 0, the secondary cell is the second carrier type.

DRS Based Transmission Schemes

If the cell-specific reference signals (CRS) exist in a physical resource block (PRB) (for example, for the purpose of time and frequency tracking), UE 116 is configured to receive PDSCH in the PRB using the CRS for channel estimation. If the cell-specific reference signals are configured in a PRB, UE 116 receives PDSCH in the PRB using the CRS for channel estimation. That is, the PDSCH transmission scheme is based on CRS (for example, single antenna port 0, or single antenna ports 0 and 1) where a transmit diversity scheme such as SFBC can be used.

In certain embodiments, a CRS based transmission scheme also is used in resource blocks where DM-RS may collide with other essential physical signals such as PSS/SSS. For example, in the middle 6 RBs of a subframe, a collision may occur in subframes 0 and 5 of a radio frame.

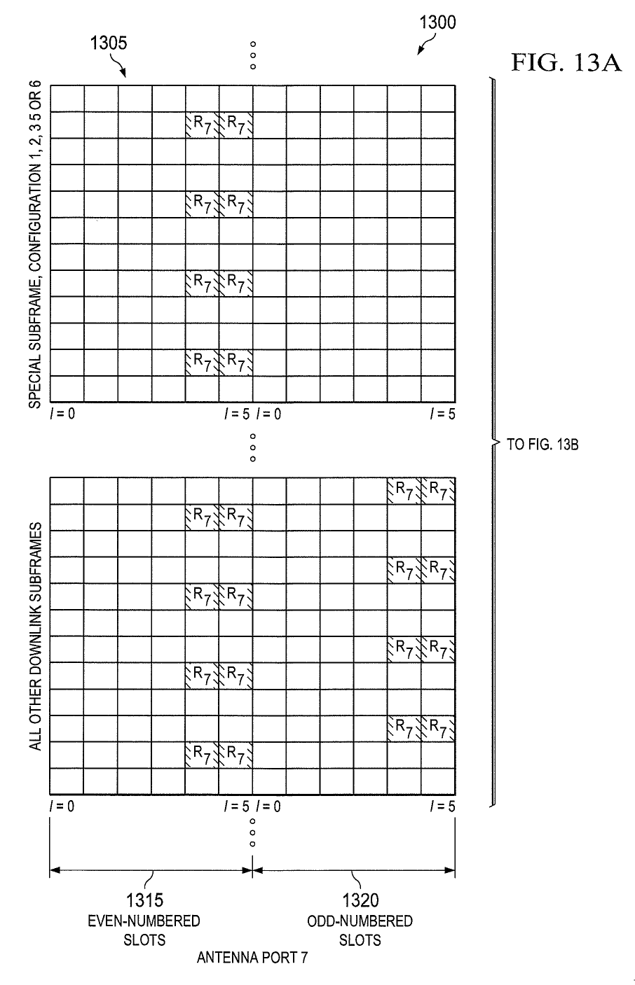

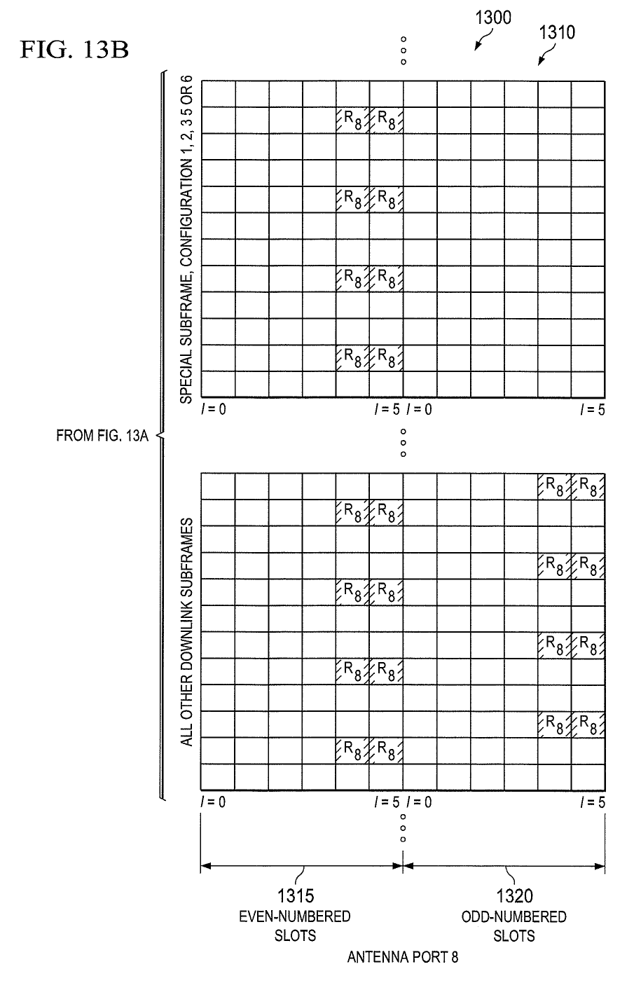

FIG. 13 illustrates a mapping of UE-specific reference signals, antenna ports 7 and 8 for an extended cyclic prefix according to embodiments of the present disclosure. The embodiment of the mapping of UE-specific reference signals 1300 shown in FIG. 13 is for illustration only. Other embodiments could be used without departing from the scope of this disclosure.

In certain embodiments, the mapping of UE-specific reference signals 1300 is used for the Basic DM-RS TS. In the example shown in FIG. 13, the UE-specific reference signals 1300 are allocated to antenna port 7 1305 and antenna port 8 1310. However, as other mapping and different ports can be used in accordance with the present disclosure. A PRE pair is composed of two time slots, slot 0 1315 and slot 1 1320, and each slot comprises six (6) OFDM symbols in extended-CP subframes. The UE-specific reference signals (UE-RS) resource element (RE) locations are denoted with a “Rₓ” indicating the RE allocated.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless network, a base station configured to communicate with a plurality of subscriber stations, the base station comprising:
a transmit path configured to transmit data and control information on a non-backwards compatible extension carrier;
processing circuitry coupled to the transmit path and configured to select a Basic Demodulation Reference Signal Transmission Scheme (Basic DM-RS TS) of Physical Downlink Shared Channel (PDSCH) corresponding to Enhanced Physical Downlink Control Channel (EPDCCH), wherein the Basic DM-RS TS uses DM-RS ports for PDSCH transmission using DCI format 1A.

2. The base station as set forth in claim 1, wherein the Basic DM-RS TS 2 is a transmit diversity transmission scheme that uses DM-RS port 7 and DM-RS port 8.

3. The base station as set forth in claim 2, wherein the transmit diversity transmission scheme is Space Frequency Block Coding (SFBC).

4. The base station as set forth in claim 1, wherein the processing circuitry is further configured to use a default transmission mode, the default transmission mode comprising.

5. The base station as set forth in claim 1, wherein the processing circuitry is further configured to:
send a higher layer signaling to a subscriber station within the plurality of subscriber stations, and
select a Basic DM-RS TS based on a value of the higher layer signaling,
wherein when the higher layer signaling comprises a value of zero, Basic DM-RS TS 1 is the selected Basic DM-RS TS, and
when the higher layer signaling comprises a value of one, Basic DM-RS TS 2 is the selected Basic DM-RS TS.

6. The base station as set forth in claim 1, wherein the processing circuitry is capable of scheduling the PDSCH transmission by EPDCCH with a scrambled (CRC) scrambled by any of:
Cell Radio Network Temporary Identifier (C-RNTI);
System Information Radio Network Temporary Identifier (SI-RNTI);
Paging Radio Network Temporary Identifier (P-RNTI);
Random Access Radio Network Temporary Identifier (RA-RNTI); and
Semi-Persistent Scheduling Radio Network Temporary Identifier (SPS-RNTI).

7. For use in a wireless network, a method for communicating with a plurality of subscriber stations, the method comprising:
transmitting data and control information on a non-backwards compatible extension carrier;
selecting a Basic Demodulation Reference Signal Transmission Scheme (Basic DM-RS TS) of Physical Downlink Shared Channel (PDSCH) corresponding to Enhanced Physical Downlink Control Channel (EPDCCH), wherein the Basic DM-RS TS uses DM-RS ports for PDSCH transmission using DCI format 1A.

8. The method as set forth in claim 7, further comprising:
indicating the selected Basic DM-RS TS using a value of the higher layer signaling, wherein:
when the higher layer signaling comprises a value of zero, selecting Basic DM-RS TS 1, and
when the higher layer signaling comprises a value of one, selecting Basic DM-RS TS 2.

9. The method as set forth in claim 7, further comprising scheduling the PDSCH transmission by EPDCCH with a scrambled (CRC) scrambled by any of:
Cell Radio Network Temporary Identifier (C-RNTI);
System Information Radio Network Temporary Identifier (SI-RNTI);
Paging Radio Network Temporary Identifier (P-RNTI);
Random Access Radio Network Temporary Identifier (RA-RNTI); and
Semi-Persistent Scheduling Radio Network Temporary Identifier (SPS-RNTI).

10. For use in a wireless network, a user equipment (UE) configured to communicate with at least one base station, the UE comprising:
a receive path configured to receive data and control information from a carrier of a first type and a carrier of a second type of the at least one base station,
wherein the second type carrier is a non-backwards compatible extension carrier, and
wherein the first type carrier is one of:
a LTE Release 8 carrier,
a LTE Release 9 carrier,
a LTE Release 10 carrier, and
a LTE Release 11 carrier;
processing circuitry coupled to the receive path and configured to select, based on the carrier type, at least one of:
a Basic demodulation reference signal transmission scheme (DM-RS TS) for PDSCH demodulation for a transmission mode,
a downlink power allocation assumption,
a basic DM-RS TS for CSI feedback, and
a default transmission mode to use for a carrier,
wherein the processing circuitry is configured to receive, from the at least one base station, UE-specific signaling indicating the carrier type.

11. The subscriber station as set forth in claim 10, wherein the processing circuitry is further configured to:
when implementing a transmission mode 8, set a ratio of PDSCH EPRE to UE-specific RS EPRE is 0 decibels (dB);
when implementing a transmission mode 9, when a number of transmission layers is less than or equal to two, set the ratio of PDSCH EPRE to UE-specific RS EPRE is 0 dB; and
when implementing a transmission mode 9, when the number of transmission layers is greater than two, set the of PDSCH EPRE to UE-specific RS EPRE is −3 dB.

12. The subscriber station as set forth in claim 10, wherein the processing circuitry is further configured to:
derive a Channel Quality Indicator (CQI) based on at least one of:
zero OFDM symbols occupied by control signaling;
no resource elements used by primary or secondary synchronization signals or by PBCH;
CP length of the non-MBSFN subframes; and
Redundancy Version 0.

13. The subscriber station as set forth in claim 10, wherein the processing circuitry is further configured to:
receive signals according to a Basic DM-RS TS for CSI feedback from the at least one base station; and
derive the CSI,
wherein when the Basic DM-RS TS for CSI feedback is Basic DM RS TS 1, the CSI derived as if only one CSI-RS port is configured, and
wherein, when the Basic DM-RS TS for CSI feedback is Basic DM-RS TS 2:
channels estimated on CSI-RS port 15 are the same as channels estimated on DM-RS port 7; and
channels estimated on CSI-RS port 16 are the same as channels estimated on DM-RS port 8.

14. The subscriber station as set forth in claim 10, wherein when the at least one base station receives a higher layer signaling and selects a Basic DM-RS TS based on a value of the higher layer signaling, the selection comprises:
when the higher layer signaling comprises a value of zero, Basic DM-RS TS 1, and
when the higher layer signaling comprises a value of one, Basic DM-RS TS 2.
